(19) United States
(12) Patent Application Publication
(10) Pub. No.: US 2004/0021597 A1
(43) Pub. Date: Feb. 5, 2004

(54) Optimization of electromagnetic absorption in laminated composite plates

(76) Inventors: George J. Dvorak, Albany, NY (US); Karel Matous, Troy, NY (US)

Correspondence Address: RATNERPRESTIA, P O BOX 980, VALLEY FORGE, PA, 19482-0980, US

(21) Appl. No.: 10/431,476

(22) Filed: May 7, 2003

Related U.S. Application Data
(60) Provisional application No. 60/378,584, filed on May 7, 2002.

(51) Int. Cl. H01Q 17/00

(52) U.S. Cl. 342/1; 342/2; 342/3; 342/4

(57) ABSTRACT

A method of minimizing reflectivity of an electromagnetic absorbing structure within a prescribed frequency range, including at least one skin layer having a thickness, at least one spacer layer having a thickness, and at least one resistivity sheet having a resistivity. Then, the thicknesses of the at least one skin layer, the at least one spacer layer, and the at least one resistivity sheet are determined.

### RELATED APPLICATION

This application claims the benefit of priority to U.S. Provisional Patent Application Serial No. 60/378,584, filed on May 7, 2002, the contents of which are incorporated in this application by reference.

### GOVERNMENT RIGHTS

This invention was made with government support under Grant No. N00014-94-1-0277 awarded by the Office of Naval Research. The government has certain rights in this invention.

### TECHNICAL FIELD

The present invention relates generally to a method used to optimize radar-absorbing structures. More specifically, the invention relates to a method to design layered absorbers on structures, such as ship structures. The method may be applied either on structural surfaces or within sandwich plate structures.

### BACKGROUND OF THE INVENTION

Various devices and methods to absorb electromagnetic energy (such as microwaves and radar) have been developed. Absorbers may be used on a variety of structures.

U.S. Pat. No. 4,038,660 issued to Connolly et al. discusses the use of Jaumann-type absorbers, which use dielectric and absorbing layers placed on reflecting surfaces and in which the laminated layers are resistive layers separated by dielectric spacing layers. The patent discloses a way to fabricate Jaumann absorbers because they are difficult to construct from the point of view of accuracy and reproducibility. The patent is based on the discovery that the spacing layer thickness, and the homogeneity and isotropy of the resistive layer, as well as the nominal admittance of the resistive layer, are critical components of the absorber. The spacing layers have a thickness equal to or less than one-fourth of the wavelength at the highest frequency and a thickness such that the total thickness of the absorber is equal to or greater than one-half of the wavelength at the lowest frequency to be absorbed. The preferred embodiment has six dielectric foam layers and six semi-conductive resistive layers. The dielectric or spacer layers are cut from sheets of closed-cell foamed polyethylene. The resistive layer uses pulverulent carbon.

U.S. Pat. No. 5,275,880 issued to Boyer, III et al. discloses a microwave absorber for direct surface application. The structure uses a layered microwave radiation absorber comprising an absorbing layer bound to one side of a conductive layer and an adhesive layer bound on the other side of the conductive layer. The absorber can be is applied directly to any object, especially a conductive object having a nonconductive coating (typically paint). The patent also discloses layered absorbers adapted for application directly onto a surface which is not perfectly smooth, such as a bulkhead having rivet or bolt heads extending slightly above the surface.

U.S. Pat. No. 5,576,710 issued to Broderick et al. discloses an electromagnetic absorber using a layered material that absorbs microwave radiation over a wide range of operating frequencies. The base has a dielectric layer over it and an impedance layer over the dielectric layer. An outermost dielectric skin covers those two layers. The dielectric material can be an epoxy resin-based, microballoon-filled syntactic foam. The impedance layer can be a resistive sheet formed into a broken pattern that can comprise a series of geometric shapes spaced from each other.

U.S. Pat. No. 5,976,666 issued to Narang et al. discloses devices for shielding from and absorption of broadband electromagnetic radiation. The devices use a perforated electrical absorbing layer containing conductive polymers laminated to a metal plate. Additional layers may include more electrical absorbing layers, magnetic absorbing layers, and impedance matching layers. The patent recognizes that the bandwidth absorber can be improved by adding resistive sheets and spacers to form a Jaumann absorber. A series of equations are used to analyze the properties of the absorbing layer which is fabricated from composites containing a plurality of perforations reducing to the lowest possible level the energy reflected back from an incident wave.

U.S. Pat. No. 6,037,046 issued to Joshi et al. discloses a multi-component electromagnetic wave absorption panel for use in building construction. The panel includes a protective tile layer, an absorber layer, a metal reflective layer, and a building support layer (such as concrete). Two of the materials are a polymer and a polymer-ceramic composite. The panel prevents reflection of electromagnetic waves from buildings. The absorbers can be tuned to cover a wide frequency range by selecting specific materials in a composite, by varying the thickness of the layers of each component in a composite, and by combinations of the foregoing. The patent discloses equations for determining thickness based on wavelength of the incident wave. The patent also discloses that the impedance of adjacent layers should be approximately equal.

An article by T. Wong et al. titled “Fabrication and Evaluation of Conducting Polymer Composites as Radar Absorbers,” published by the Eighth International Conference on Antennas and Propagation (ICAP) in 1993, reports the fabrication and characterization of polymer polypyrrole (PP)-loaded fabrics and their application in microwave absorbing structures. The article discloses that composites which are heavily loaded with PP exhibit values of reflectivity essentially independent of frequency and explains why the use of cloth is better than paper substrates. Also disclosed is a broadband Jaumann design using two layers of PP-loaded paper.

A chapter on “Radar Absorbing Materials” (RAM), written by M. Tuley and published by Artech House in 1993, discusses different types of absorbers: Salisbury screens, Dallenbach layers, and Jaumann absorbers. The chapter discloses that the optimum method for design of a Jaumann absorber would be to determine analytically the μ (permeability) and ε (permittivity) required as a function of distance into the material to limit |R| (reflection coefficient) over a given frequency range, subject to incidence angle and thickness constraints. The chapter notes, however, that this general form of the problem has not yet been solved. A hybrid RAM is disclosed for wide-band operation that includes low frequencies employing a back layer of magnetic material, with front layers of Jaumann absorbers. For aerospace applications, the chapter notes that there are problems in designing the front face for a honeycomb that meets mechanical requirements with minimum reflection of incoming energy.

A publication by K. Matous et al. titled “Applying Genetic Algorithms to Selected Topics Commonly Encountered in Engineering Practice,” published by Computer Methods in Applied Mechanics and Engineering (2000), discloses that genetic algorithms can be used in various engineering optimization domains to provide a desired solution over a broad class of optimization problems. The authors disclose that their technique can be used to improve the overall mechanical performance of composite structures, such as laminated plate.

To overcome the shortcomings of previous microwave absorbers, a new method of designing and optimizing such structures is provided. An object of the present invention is to provide the theoretical and computational framework for a method that increases the microwave absorption capabilities of previous and newly designed absorbers. A related object is to provide absorbers with optimized thicknesses and resistivities of absorbing sheets. Another object is to provide absorbers having optimum structures, including an optimized number of layers with optimized thicknesses and optimized resistivities of absorbing sheets. Yet another object is to provide a tailored material systems design that may be able to minimize the radar signature of marine structures over a specified frequency range.

### SUMMARY OF THE INVENTION

To achieve these and other objects, and in view of its purposes, the present invention provides a method of minimizing reflectivity of a radar absorbing structure having at least one skin layer having a thickness, at least one spacer layer having a thickness, and at least one resistivity sheet having a resistivity. The method comprises specifying a frequency range over which to operate the radar absorbing structure. Then, the thicknesses of the at least one skin layer, the at least one spacer layer, and the at least one resistivity sheet are specified.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a diagrammatic representation of a composite laminated plate;

FIG. 2(a) shows an exemplary embodiment of localized frequency weight functions in selected frequency ranges;

FIG. 2(b) shows an exemplary embodiment of broadband frequency weight functions in selected frequency ranges;

FIG. 3 shows an exemplary embodiment of angle weight function in selected ranges of oblique incident waves;

FIG. 4 is shows an exemplary embodiment of a penalty function;

FIG. 5 is a graph having curves comparing the performance of the Connolly patented absorber with the optimized Jaumann absorbers in the frequency range of 8-18 GHz;

FIG. 6(a) is a configuration of a Type A analyzed embedded absorber with free or metallic backing;

FIG. 6(b) is a configuration of a Type B analyzed embedded absorber with free or metallic backing;

FIG. 6(c) is a configuration of a Type C analyzed embedded absorber with free or metallic backing;

FIG. 6(d) is a configuration of a Type D analyzed deposited absorber with free or metallic backing;

FIG. 7(a) is a graph with curves showing reflection coefficients of embedded Type A layups, with sheet resistivities and foam and/or laminate thicknesses optimized using different weight functions in the 8-12 GHz range;

FIG. 7(b) shows the dimensions in millimeters of the layers of a Type A₁ optimized absorber;

FIG. 7(c) shows the dimensions in millimeters of the layers of a Type A₂ optimized absorber;

FIG. 7(d) shows the dimensions in millimeters of the layers of a Type A₃ optimized absorber;

FIG. 8(a) is a graph with curves showing reflection coefficients of embedded Type B layups, with sheet resistivities and foam and/or laminate thicknesses optimized using different weight functions in the 8-12 GHz range;

FIG. 8(b) shows the dimensions in millimeters of the layers of a Type B₁ optimized absorber;

FIG. 8(c) shows the dimensions in millimeters of the layers of a Type B₂ optimized absorber;

FIG. 8(d) shows the dimensions in millimeters of the layers of a Type B₃ optimized absorber;

FIG. 9(a) is a graph with curves showing reflection coefficients of embedded Type C layups, with sheet resistivities and foam and/or laminate thicknesses optimized using different weight functions in the 8-12 Ghz range;

FIG. 9(b) shows the dimensions in millimeters of the layers of a Type C₁ optimized absorber;

FIG. 9(c) shows the dimensions in millimeters of the layers of a Type C₂ optimized absorber;

FIG. 9(d) shows the dimensions in millimeters of the layers of a Type C₃ optimized absorber;

FIG. 10(a) is a graph with curves showing reflection coefficients of deposited Type D layups, with sheet resistivities and foam and/or laminate thicknesses optimized using different weight functions in the 8-18 GHz range;

FIG. 10(b) shows the dimensions in millimeters of the layers of a Type D₁ optimized absorber;

FIG. 10(c) shows the dimensions in millimeters of the layers of a Type D₂ optimized absorber; and

FIG. 11 is a graph with curves showing convergence of the genetic algorithm for a Type D₂ absorber with free space.

### DETAILED DESCRIPTION OF THE INVENTION

The design of radar absorbing materials is associated with the selection and spatial arrangement of dielectric and magnetic materials that may provide a specified impedance profile to an incident wave of electromagnetic energy. An exemplary embodiment of this specification describes how to design deposited Jaumann and/or embedded layered absorbers which may be applied, for example, to ship structures. In an alternative embodiment, the absorbers disclosed in this document may be used on other structures such as airplanes, rockets, buildings, and any structure that may absorb electromagnetic waves to reduce the electromagnetic signature. In an exemplary embodiment, the layered absorbers comprise outer layers, or skin layers, made of glass/epoxy laminates and spacer foam interlayered with carbon resistive sheets.

The layered absorbers are designed using an optimization procedure, based on genetic algorithms (GA's), for minimization of at least one objective function. In an exemplary embodiment, the optimization procedure may produce optimized absorbing layer configurations, which may be applied at the surface structure. Such surface applications may be represented by a Jaumann absorber with an optimized distribution of both carbon sheet resistivities and foam spacer thicknesses that substantially improve the performance of a conventional absorber configuration.

In an alternative embodiment, the optimization procedure may produce optimized absorbing layer configurations, which may be applied within a sandwich plate structure and are referred to as embedded, interior absorbers. Here, interior absorbing layers are separated by either two or three foam spacers of optimized thickness and are bonded to exterior glass/epoxy laminates. Such interior absorbing layers may offer, for example, a range of reflection coefficient values within the prescribed bandwidth. In still another embodiment, the optimization procedure may produce optimized absorbing layer configurations which may be applied to surface absorbers and to internal absorbers on and within a single structure.

In general, Jaumann surface absorbers, where the outermost, skin, layer is created by using a resistive sheet and/or foam spacer, are usually not suitable for direct structural applications because these materials do not have good mechanical and environmental resistance. Although performance of microwave absorbers is crucially influenced by skin behavior, such influence has not been incorporated in the overall optimization. For example, in an article by B. Chambers et al. entitled “Optimized Design of Jaumann Radar Absorbing Materials Using a Genetic Algorithm,” published in IEEE Proceeding-Radar Sonar and Navigation, vol. 143, no. 1, pp. 23-30 (1996), the authors describe how skin having a thickness of 1 mm deteriorates electromagnetic absorption. Chambers et al. proposed, in their article, secondary re-optimization strategy to enhance absorbing behavior. In the inventors' approach, the skin thickness which might be subjected to constraints such as, for example, stiffness requirements and structural strength, is optimized all together with other design variables as described below. Moreover, the inventors' approach can be used, for example, for coupled optimization problems, where both mechanical and electromagnetic responses are considered.

In addition, in order to be effective, electromagnetic absorbers in tailored material systems subjected to oblique incident waves must operate over a specific frequency spectrum and the optimization of their performance involves the solution of an N-dimensional optimization problem. Experience before the inventors' development of their invention showed that many conventional optimization techniques are unsuitable for this optimization problem. Moreover, most of the GA's for RAM are narrowband or, if wideband, are non-optimum in performance. For certain applications, however, some frequency range is dominant over the rest of the radar spectrum. In those applications, the prior techniques based on an optimization within a large frequency band with a constant desired reflection coefficient can fail or provide a non-optimum solution.

Therefore, the invention described in this document uses a set of weight functions modifying the shape of the objective function to develop solutions in a smaller interval defined by the dominant radar bandwidth, ƒ₁, ƒ₂, but still provides good response out of this narrow band. The invention uses two types of weight functions. First, there is a weight function that provides the required shape of the objective function and leads to optimized design with decreased radar signature within the specific radar bandwidth ƒ₁, ƒ₂. Second, there are weight functions for oblique incident waves, where the weight coefficients may be distributed to influence the optimum performance for specific angles of incidence. The inventors' approach based on an objective function weighting is capable of finding an optimum solution for both narrowband and wideband frequency spectrum applications.

A. Electromagnetic Theory

The following concepts in electromagnetic theory are known. Electromagnetic waves in free space or dielectric medium are governed by a set of Maxwell's equations, which relate field and flux variables among themselves and to sources,

$$\begin{matrix}∇ \times E = - \frac{\partial B}{\partial t} & ∇ \cdot B = 0 \\ ∇ \times H = J + \frac{\partial D}{\partial t} & ∇ \cdot D = ρ\end{matrix} \qquad ( 1 )$$

where E[V/m] is electric field intensity, D[C/m²] denotes electric displacement flux density, H[A/m] denotes magnetic field intensity, B[Wb/m²] denotes magnetic induction, J[A/m²] is electric current density, and ρ[C/m³] denotes electric charge density. The electromagnetic constitutive equations for an isotropic material are given by,

D=εᵣε₀E B=μᵣμ₀H J=σE (2)

wherein ε₀=8.854·10⁻¹² F/m, μ₀=0.4π·10⁻⁶H/m are permittivity and permeability of the free space, εᵣ=(εᵣ′,εᵣ″),μᵣ=(μᵣ′,μᵣ″) are non-dimensional complex relative material permittivity and permeability, and σ[S/m] denotes conductivity of the material. The wave equation for electric field in a conductive medium can be written in the form,

∇²E=−iωμ(σ−iωε)E (3)

where ω[rad/s] denotes circular frequency. All bold symbols represent vectors from R³.

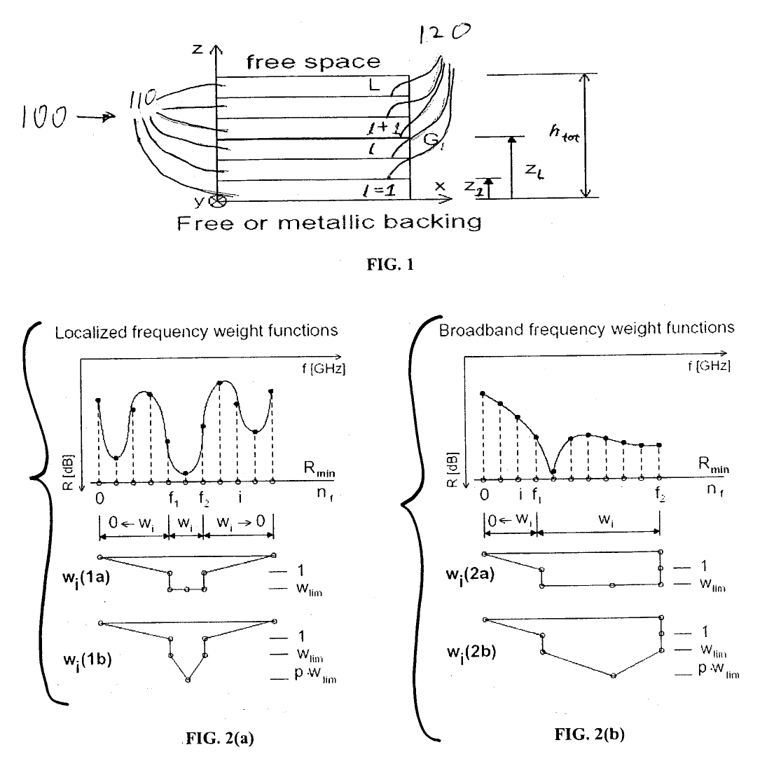

Evaluation of the reflection of an incident plane wave from an infinite flat multilayer structure involves application of boundary conditions, derived from Maxwell's equations, to the general solution for the electric and magnetic field in each layer as discussed in the book by E. Knott et al. titled “Radar Cross Section,” published by Artech House in 1993. FIG. 1 is a diagrammatic representation of a composite laminated plate. It shows a free or metallic backing before the first layer l=1 and shows free space after the last layer L, that is, outside the structure. Considering the composite laminated plate 100 composed of L different dielectric layers 110, as shown in FIG. 1, it is assumed that impedance sheets 120 of zero thickness are sandwiched between the layers 110. The complex form of the electric and magnetic fields associated with a plane wave in a given layer is,

Ê=Ê⁻·e^{-ikz}+Ê⁺·e^{ikz}

|Ĥ|=Y|Ê| (4)

where Ê⁻ and Ê⁺ represent the amplitudes of forward and backward propagating waves, and Y is the layer intrinsic admittance. The boundary conditions which must be satisfied at the interfaces are,

GÊₗ₊₁=GÊₗ=J

Ĥₗ₊₁−Ĥₗ=J (5)

where G=1/R^{s}[ [symbol] /□] is the sheet conductance, R^{S}=1/G [Ω/□] is the sheet resistance, and J is the current flowing in the sheet.

A stepping procedure is developed by substituting Equation (5) into Equation (4), which yields expressions for the coefficients Êₗ₊₁⁺, Êₗ₊₁⁻ in the terms of Êₗ₊₁⁺, Êₗ₊₁⁻. Only one case can be considered for the normal incidence, where the coefficients Êₗ₊₁⁺ and Êₗ₊₁⁻ are given by

$$\begin{matrix}{\hat{E}}_{l + 1}^{-} = \frac{{ⅇ}^{ⅈ {k}_{l + 1} {z}_{l}}}{2 {Y}_{l + 1}} [ {E}_{l}^{-} ( {Y}_{l + 1} + {Y}_{l} + G ) {ⅇ}^{- ⅈ {k}_{l} {z}_{l}} + {\hat{E}}_{l}^{+} ( {Y}_{l + 1} - {Y}_{l} + G ) {ⅇ}^{ⅈ {k}_{l} {z}_{l}} ] \\ {\hat{E}}_{l + 1}^{+} = \frac{{ⅇ}^{- ⅈ {k}_{l + 1} {z}_{l}}}{2 {Y}_{l + 1}} [ {E}_{l}^{-} ( {Y}_{l + 1} - {Y}_{l} - G ) {ⅇ}^{- ⅈ {k}_{l} {z}_{l}} + {\hat{E}}_{l}^{+} ( {Y}_{l + 1} + {Y}_{l} - G ) {ⅇ}^{ⅈ {k}_{l} {z}_{l}} ] .\end{matrix} \qquad ( 6 )$$

Arbitrary values of the coefficients of the fields Êₗ₌₁⁺, Êₗ₌₁⁻ are assigned in the first interior layer l=1, then the program steps back from the first layer outward to calculate the value of each Êₗ⁺, Êₗ⁻, ∀l ε<2,L+1>. For a free space backing beyond the structure, no wave will be traveling back to the L+1 layer, hence Êₗ⁺=0, Êₗ⁻=1 at z=0, l=1. If there is a metallic backing instead of a free space, the total electric field must vanish, and according to Equation (4), Êₗ⁺=−Êₗ⁻, at z=0, l=1. The assignment Êₗ⁻=1, Êₗ⁺=−1 satisfies this particular condition, but creates an arbitrary amplitude that ultimately cancels out when the reflection coefficient is calculated. The stepping sequence is iterated until the L+1 layer is reached, which is the free space outside the structure. Thus, the reflection coefficient, \overline{R}, of the structure is simply,

$$\begin{matrix}\overline{R} = \frac{{\hat{E}}_{L + 1}^{+}}{{\hat{E}}_{L + 1}^{-}} & R [ dB ] = 20 log \vert \overline{R} \vert .\end{matrix} \qquad ( 7 )$$

B. Design of Tailored Material Systems for Optimal EM Performance

The objective of tailored material systems design is, for example, to minimize the radar signature of marine structures. Although selection of suitable exterior shape can provide a dramatic signature reduction over a limited range of aspect angles, absorption of the incident electromagnetic energy is the main line of defense against detection. The electromagnetic properties of layered radar absorbing materials systems that provide a specific impedance profile to an incident wave depend on the layup sequence of dielectric and magnetic layers and their properties. The loss mechanism is typically provided by carbon which converts the electromagnetic energy into heat. But energy absorption does not necessarily require carbon. For marine radar operating in the microwave frequency range of 8 to 12 GHz, the absorbed bandwidth can be increased by protective sandwich plates that contain several resistive sheets separated by a spacer layer having a thickness, a permittivity, and a permeability. In an exemplary embodiment, the spacer layer may be foam. In alternative embodiments, the spacer layer may be a lattice structure or a space truss structure made of nonmagnetic metal such as aluminum or titanium. In other alternative embodiments, the spacer layer may be made of polymer, ceramic materials, balsa wood, paper based materials, or organic materials. Selection of useful designs and evaluation of their optimized dimensions for maximum absorption in a specified frequency range is described below.

The invention may provide an optimized form of a real-valued vector X={x₁ . . . xᵥ} of v design variables corresponding to the thicknesses of the layers hₗ [m] and to the conductances Gₗ=1/Rₗ^{s}[ [symbol] /□] of the sheets. In an exemplary embodiment, for a four-layer sandwich containing two resistive sheets, the vector of design variables has the form,

X={h₁,h₂,h₃,h₄,G₁,G₂} k=1 . . . ,v=6. (8)

In the context of genetic algorithms, the vector X may be referred to as a chromosome, and the variables Xₖ as genes. Floating-point representation of genes is used in the implementation. A normalized objective function ƒ(X) ε<0,1>is selected as a sum of least squares of reflection coefficients R in [dB], Equation (7), through the frequency spectrum i ε<0, n_{ƒ}>. If applied to a formulation involving oblique incidence, the objective function would have to be optimized for angles j ε<0, nₐ>of the incident wave. In this case,

$$f ( X ) = \frac{1}{{R}_{nor}} {\sum }_{i = 1}^{{n}_{f}} {\sum }_{j = 1}^{{n}_{a}} {w}_{i} {{w}_{j} [ {R}_{min} - {R}_{ij} ]}^{2} + {\sum }_{k = 1}^{v} {p}_{k} \qquad ( 9 )$$

where Rₘᵢₙ is a desired reflection coefficient of the sandwich plate, n_{ƒ}is the number of analyzed frequencies i, and nₐ is the number of analyzed angles j. An object of the invention is to minimize the function in Equation (9) to obtain the best reflection coefficient, hence to design structures with optimal absorption. The normalization parameter Rₙₒᵣ denotes maximum reflectivity for

$${R}_{ij} = 0 , {\sum }_{k}^{v} {p}_{k}$$

denotes the sum of penalty functions, and wᵢ and Wⱼ denote selected frequency and angle weight functions.

The specific weight functions wᵢ, Wⱼ play a very important role in the optimization procedure as they may substantially increase the efficiency of the optimization algorithm and provide the required shape of the objective function. In prior techniques, there was an absence of weight functions and the optimal solution was sought in a large search space with a constant desired reflection coefficient. In contrast, the method of this invention finds solutions in a smaller interval, defined by the dominant radar bandwidth, ƒ₁, ƒ₂, but still provides good response out of this narrowband. In the absence of weight functions, the optimal solution is sought in a large search space, while the problem at hand calls for such solutions in a smaller interval, defined by the radar bandwidth ƒ₁, ƒ₂.

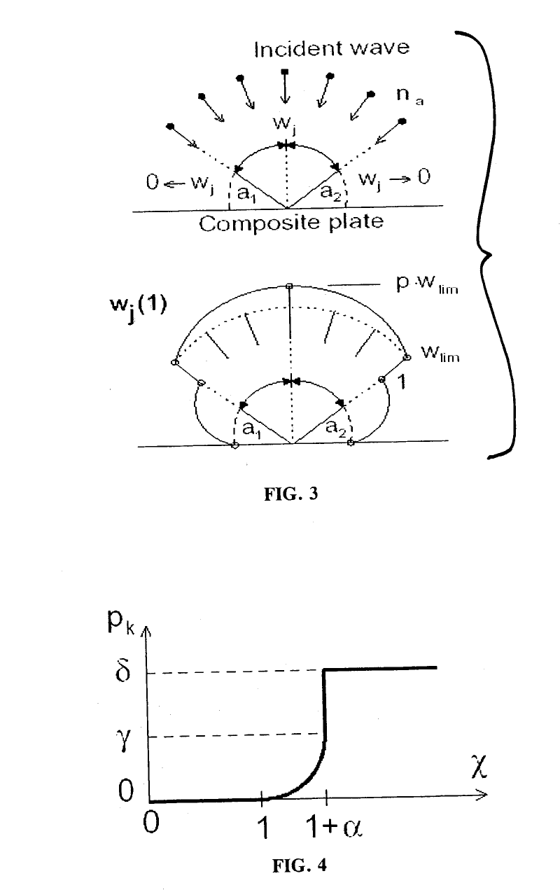

Two types of weight functions are developed by the inventors, as shown in FIGS. 2(a), 2(b), and 3. FIG. 2(a) displays the localized types wᵢ(1a) and wᵢ(1b) that provide the shape of the objective function required within a selected interval of the radar bandwidth ƒ₁, ƒ₂. Efficient, low-reflectivity designs can be obtained in this manner, but their utility is limited to the selected interval. FIG. 2(b) shows the broadband weight functions wᵢ(2a) and wᵢ(2b) which cover a wider frequency spectrum, but may yield higher reflectivity peaks than the localized functions. FIG. 3 illustrates exemplary weight function selections Wⱼ, for oblique incident waves, where the weight coefficients may be distributed to influence the optimal performance for specific angles of incidence.

The last term

$${\sum }_{k}^{v} {p}_{k}$$

in Equation (9) represents penalties to handle constraints, such as the minimum and maximum thickness of the layers and minimum and maximum conductance of the sheets,

hₘᵢₙ≦hₗ≦hₘₐₓ

Gₘᵢₙ≦G₁≦Gₘₐₓ (10)

In an exemplary embodiment, hₘᵢₙ=2 mm was selected for the foam layer and hₘᵢₙ=5 mm for the laminate, hₘₐₓ=30 mm, Gₘᵢₙ=1/50 [symbol] /□, Gₘₐₓ=1/10000 [symbol] /□. Values of the remaining parameters Rₘᵢₙ, nₐ, n_{ƒ}, ƒ₁, ƒ₂, v, and selection of weight functions, wᵢ, wⱼ, are discussed below.

The penalty function pₖ assumes, in general, the form displayed in FIG. 4. In an exemplary embodiment, a variable Fₖ=(h₁, . . . , h_{L},G₁ . . . ,G_{L}), ∀k ε<1,v>, should not exceed the allowable intervals of Equation (10),

F_{k,min}≦Fₖ≦F_{k,max}. (11)

To formulate a penalty function pₖ, a parameter χ is first introduced such that,

$$χ = \vert \overline{χ} \vert \overline{χ} = \frac{2}{{F}_{k , min} - {F}_{k , max}} ( {F}_{k , max} - {F}_{k} ) + 1. \qquad ( 12 )$$

Then, according to FIG. 4, the function Pₖ=0 on a closed interval <0,1>. For χ>(1+α) the penalty term is set at Pₖ=δ, but for interval (1,1+α) we define

$${p}_{k} = {γ ( \frac{χ - 1}{α} )}^{β} \qquad ( 13 )$$

where α, β, γ and δ are user-defined parameters. A large number is assigned to the parameter β→∞, whereas α>0 and the parameter γ≦δ. In an exemplary embodiment of a normalized objective function ƒ(X) ε<0,1>, we set β=5.0, and γ=δ=1.0. For α=0.05 the design variable xₖ can exceed minimum and maximum values by 5%, with the penalization pₖ of the normalized objective function ƒ(X).

The analysis and optimization algorithm according to the present invention may generally be described as follows.

1) Problem Description and Input Parameters

The goal is to optimize absorption of electromagnetic energy of sandwich composite plates, for example, in a certain radar frequency range. The optimization parameters, or design variables, for achieving maximum absorption are thicknesses of individual plies and conductances and/or resistances of resistive sheets, which are either deposited on different backing materials or embedded in a laminated sandwich plate.

Before the optimization process begins, the initial, user-defined parameters must be set:

minimum and maximum thickness of the layers: hₘᵢₙ≦hₗ≦hₘₐₓ;

minimum and maximum conductances of the sheets: Gₘᵢₙ≦Gₗ≦Gₘₐₓ;

radar frequency range in which behavior should be optimal: ƒ₁≦ƒ≦ƒ₂;

and desired reflection coefficient one would like to obtain: Rₘᵢₙ.

One also has to specify and calibrate the weight function, which is used in optimization. Next, one has to calibrate the penalty function Equation (13). Finally, optimization parameters, such as the number of population numbers N, size of mating pool m, number of genetic iteration cycles and cooling schedules, have to be specified. To calibrate all of the parameters listed above, one must have some knowledge of electromagnetic and optimization theories.

2) Optimization Algorithm.

Genetic algorithms (GA's) are formulated using a direct analogy with evolution processes observed in nature, where individuals in a population compete with each other for survival, so that fitter individuals tend to progress into new generations while the unfit ones usually die out. In contrast to traditional methods, genetic algorithms work simultaneously with a population of individuals, exploring a number of new areas in the search space in parallel, thus reducing the probability of being trapped in a local minimum. The method starts with a selected thickness and conductance of each layer of the absorber and uses the exemplary genetic algorithm to find an optimal solution. This method is briefly described in the eight-step Algorithm below.

| 1 | g = 0 | |
|---|---|---|
| 2 | generate and evaluate population P_{g} of size N | |
| 3 | while (not termination-condition) { | |
| 4 | select m individuals to M_{g} | (apply sampling mechanism) |
| | from P_{g} | |
| 5 | alter M_{g} | (apply genetic operators) |
| 6 | create and evaluate P_{g+1} | (insert m new individuals |
| | from M_{g} | into P_{g+1)} |

| | |
|---|---|
| 7 | g = g + 1 |
| 8 | } |

### Algorithm 1

For the optimization problem, the population P_{g} in the exemplary Algorithm 1 becomes a family of possible configurations of a sandwich composite laminated plate. For example, in an exemplary four-layer plate with the chromosome defined by Equation (8), there is a population of N members,

$$\begin{matrix}{f}_{1} ( {X}_{1} ) , & {X}_{1} = \{ {h}_{1}^{1} , {h}_{2}^{1} , {h}_{3}^{1} , {h}_{4}^{1} , {G}_{1}^{1} , {G}_{2}^{1} \} \\ ⋮ & ⋮ \\ {f}_{i} ( {X}_{i} ) , & {X}_{i} = \{ {h}_{1}^{i} , {h}_{2}^{i} , {h}_{3}^{i} , {h}_{4}^{i} , {G}_{1}^{i} , {G}_{2}^{i} \} \\ ⋮ & ⋮ \\ {f}_{N} ( {X}_{N} ) , & {X}_{N} = \{ {h}_{1}^{N} , {h}_{2}^{N} , {h}_{3}^{N} , {h}_{4}^{N} , {G}_{1}^{N} , {G}_{2}^{N} \}\end{matrix} \} ⇒ {P}_{g} \qquad ( 14 )$$

where ƒᵢ(Xᵢ) denotes the value of the objective function or “fitness” of the i^{th} chromosome. The first population P₀ can be created randomly, but an informed choice incorporated within the starting chromosome (SC) might decrease the number of GA iterations for an otherwise random population (X₁^{SC}, X₂, . . . random . . . , X_{N})εP₀.

The mating pool M_{g} represents a space for reproduction of offsprings and consists of m≧2 chromosomes. The termination condition in Step 3 of the above Algorithm 1 is determined by a chosen number of GA iterations or by a population convergence criterion. In an exemplary embodiment, the examples were solved with population size N=600, and with m=10 chromosomes in the mating pool M_{g} in each algorithm cycle. The termination criterion was set at 6,000 genetic algorithm iterations and a convergence criterion was not used.

3) Description of Main Steps of Algorithm 1

Steps 4-6 of Algorithm 1 warrant a detailed described. Step 4 recognizes that a proper selection strategy may significantly influence the ultimate performance of the GA. The selection scheme should not be based on the exact fitness values ƒi (X). In such a case the best individuals may appear in a large number of copies in a population, so that after a small number of GA cycles, all individuals start to look alike and the algorithm usually converges prematurely to a local minimum. Care must also be taken to avoid overcompression, which not only slows down the GA performance but may result in the loss of the global minimum as discussed in a book by D. Goldberg entitled “Genetic Algorithms in Search, Optimization and Machine Learning,” published by Addison-Wesley in 1989. Therefore, a linear scaling (shifting) of the fitness was incorporated into the sampling procedure,

$${s}_{i} ( X ) = \frac{( N - 1 ) ( {f}_{i} ( X ) - {f}_{min} ( X ) )}{{f}_{max} ( X ) - {f}_{min} ( X )} + 1 \qquad ( 15 )$$

where ƒₘᵢₙ(X) and ƒₘₐₓ (X) denote minimum and maximum fitness within a population, respectively. Thus, the fitness of chromosome ƒᵢ (X) ε<ƒₘᵢₙ(X), ƒₘₐₓ(X)> is linearly scaled to the interval sᵢ(X)ε<1, N>.

In selecting the m=10 individuals from a population P_{g} for mating and copying into the mating pool M_{g}, the inventors implemented a sampling mechanism called Remainder stochastic sampling without replacement (RSSwoR), commonly called roulette wheel as discussed in the book by D. Goldberg entitled “Genetic Algorithms in Search, Optimization and Machine Learning,” published by Addison-Wesley in 1989; in an article by Z. Michalewicz et al. entitled “Evolutionary Operators for Continuous Convex Parameter Spaces,” published in the Proceedings of the 3rd Annual Conference on Evolutionary Programming in 1994; and in an article by J. Baker entitled “Reducing Bias and Inefficiency in the Selection Algorithm,” published in Proceedings of the Second International Conference on Genetic Algorithms, pp. 13-21, in 1987. There are N intervals on the roulette wheel. These intervals are not even as in a normal roulette wheel, but equal to the probability of selection of each individual. For a maximization problem, this probability Pᵢ(X) for each chromosome is defined by,

$${P}_{i} ( X ) = \frac{{e}_{i} ( X )}{{\sum }_{1}^{N} {e}_{i} ( X )} {e}_{i} ( X ) = \frac{1}{ψ + {s}_{i} ( X )} {s}_{i} ( X ) \geq 0 \qquad ( 16 )$$

where eᵢ(X)=sᵢ(X) when solving a minimization problem. The parameter ψ is a small positive number that eliminates the possibility of division by zero. In the sampling procedure, the fitness sⱼ(X) of the selected individual j ε<1, m>is set equal to zero after each spin (selection) j to prevent multiple selection of the same chromosome in the next spins j=j+1, ∀j≦m.

Implementing Step 5, with reference to Equations (8), (10), and (11), a parent chromosome is denoted by X={xᵢ, . . . , xᵥ} and an offspring by X′={xᵢ^{′}, . . . , xᵥ^{′}}. The variables xₖ, k ε<1, v>represent thicknesses of the layers and conductances of the resistive sheets. Two types of genetic operators are applied to all m=10 individuals in the current mating pool M_{g}: A mutation operator that generates an offspring by changing a single variable in a parent chromosome and a crossover operator that creates an offspring by combining the variables of two parent chromosomes.

The type of operator (mutation and/or crossover) is selected with a certain probability, depending on the population and mating pool size. Let Pₘᵤₜ and P_{cro} be chosen probabilities of selection of the mutation and crossover operator in the genetic algorithm circle, respectively. A crossover operator is selected if a random number, r<P_{cro}, r ε<0,1>. In the opposite case r≧P_{cro}, a mutation operator is applied. The probability of mutation was set at Pₘᵤₜ=0.7 [symbol] P_{cro}=0.3 for all optimization problems. The various types of mutation and/or crossover operators for floating-point representation, such as Uniform mutation, Boundary mutation, No-uniform mutation, Simple crossover, Simple arithmetic crossover are selected uniformly through genetic cycles. Details regarding construction of these genetic operators can be found in an article by Z. Michalewicz et al. titled “Evolutionary Operators for continuous convex parameter spaces,” published in Proceedings of the 3^{rd} Annual Conference on Evolutionary Programming in 1994; and an article by C. Houck titled “A genetic Algorithm for Function Optimization: A Matlab implementation,” published by North Carolina State University in 1995.

Step 6 of Algorithm 1 represents the replacement procedure in the exemplary algorithm, where individuals in the mating pool replace the unfit chromosomes in a population. This replacement procedure is based on the Metropolis criterion from the Augmented Simulated Annealing Method (ASA) discussed in an article by V. Kvasni\check{c}ka entitled “Augmented Simulated Annealing Adaption of Feed-Forward Neural Networks,” published in Neural Network World, vol. 3, pp. 67-80, in 1994. This criterion allows, with a certain probability, a worse offspring to replace its better parent, and the probability is reduced by a “temperature” parameter T as the procedure converges to the global minimum. An inverse roulette wheel routine is used, with inverted fitness of individuals, which provides the m weakest individuals in the population P_{g} with a higher probability to die out. Replacement of the m individuals in the population with those from the mating pool, M_{g}→P_{g+1} is realized if the fitness of an offspring in the mating pool is higher than that of those marked for dying out, sᵢ(X′)<sᵢ(X), or if the probability of accepting is r≦Pₑₓ, r ε<0,1>,

$${P}_{ex} = exp ( - \frac{[ {s}_{i} ( {X}^{′} ) - {s}_{i} ( X ) ]}{T} ) \qquad ( 17 )$$

where Sᵢ(X) is defined in Equation (15). The temperature T is bracketed by Tₘᵢₙ≦T≦Tₘₐₓ, where Tₘᵢₙ is the value at the termination of the process and Tₘₐₓ should be chosen such that the ratio of accepted solutions to all solutions is approximately equal to 0.5≈50%. Temperature decrease is controlled by

T_{g+1}=T_{cool}T_{g}, where T_{g}=T₀=Tₘₐₓ, g=0. This process is called the cooling schedule. All parameters Tₘᵢₙ, T_{cool} and Tₘₐₓ must be suitably chosen, therefore the annealing schedule requires some experimentation depending on the optimization problem, number of members in the population N, and maximum number of iterations gₘₐₓ. In an exemplary embodiment with a normalized objective function and first average value of fitness in population approximately equal to 0.8, the cooling schedule may be set as: Tₘₐₓ=0.05, T_{cool}=0.999 and Tₘᵢₙ=0.00001.

4) Convergence of the Genetic Algorithm

Convergence depends strongly on information stored in genes of chromosomes in the population. When the population does not contain the information necessary to reach the expected converged results, the genetic algorithm then needs a large number of generation cycles. In alternative embodiments, the number of iterations can be reduced by several useful techniques. In one alternative embodiment, when the convergence of the algorithm is very slow, the optimization process can be restarted to create any missing information, which is represented by genes composing chromosomes. The several best members of a population are copied to the next population and the remaining individuals are created randomly to input new information. The optimization process then continues with the same optimization parameters, or can be started again from the beginning. This process is called re-optimization, or re-annealing for ASA as discussed in the article by V. Kvasni\check{c}ka entitled “Augmented Simulated Annealing Adaption of Feed-Forward Neural Networks,” published in Neural Network World, vol. 3, pp. 67-80, in 1994.

C. Jaumann Absorber Test Case

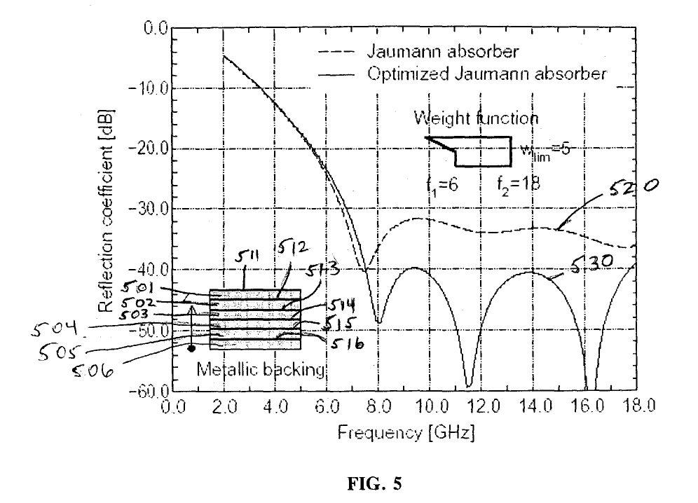

To verify the efficiency and improvement of their approach, the inventors first optimized the six-layer Jaumann absorber with the metallic backing disclosed in U.S. Pat. No. 4,038,660 issued to T. Connolly et al. (hereinafter “Connolly”). The Connolly configuration, shown schematically in the insert of FIG. 5, consists of six dielectric foam spacer layers 501, 502, 503, 504, 505, and 506 of thickness 3.56 mm each, and six resistive sheets 511, 512, 513, 514, 515, and 516 of different resistivities. FIG. 5 also includes a graph containing curves comparing the performance of the Connolly version of the Jaumann absorber with a Jaumann absorber which has been optimized in accordance with the method of the present invention. Curve 520 shows the performance of the Connolly version of the Jaumann absorber. Curve 530 shows the performance of the optimized Jaumann absorber.

Table I lists thicknesses hₗ [mm] of foam and resistance R^{s}₁=1/G [Ω/□] of sheets in the Connolly configuration of the Jaumann absorber and in the optimized configuration of the Jaumann absorber. Column 1000 in Table I refers to each of the foam layers of the absorber in FIG. 5. That is, layer 1 in Table I refers to layer 506 in FIG. 5, layer 2 in Table I refers to layer 505, and layers 3 to 6 refer to layers 503 to 501, respectively. Column 1010 in Table I provides the thicknesses in millimeters of each of the layers in the Connolly version of the Jaumann absorber. For example, the thickness of layer 1 in Table I (layer 506 in FIG. 5) is 3.56 mm. Column 1020 in Table I provides the resistance of each resistive sheet in the Connolly version of the Jaumann absorber. For example, the resistance of resistive sheet 1 in Table I (resistive sheet 516 in FIG. 5) is 236 Ω and the resistance of resistive sheet 2 in Table I (resistive sheet 515 in FIG. 5) is 471 Ω. Curve 520 in FIG. 5 tracks the response of the absorber made in accordance with columns 1000, 1010, and 1020 in Table I.

Column 1030 in Table I provides the thicknesses of the foam layers in the Jaumann absorber after optimization in accordance with the present invention. For example, the thickness of foam layer 1 (layer 506 in FIG. 5) is 3.56 mm and the thickness of foam layer 2 (layer 505 in FIG. 5) is 3.52 mm. Column 1040 provides the resistance of the resistive sheets of the Jaumann absorber after optimization in accordance with the present invention. For example, the resistance of resistive sheet 1 (resistive sheet 516 in FIG. 5) is 236 Ω and the resistance of resistive sheet 2 (resistive sheet 515 in FIG. 5) is 481 Ω. Curve 530 in FIG. 5 tracks the response of the absorber made in accordance with columns 1000, 1030, and 1040 in Table I.

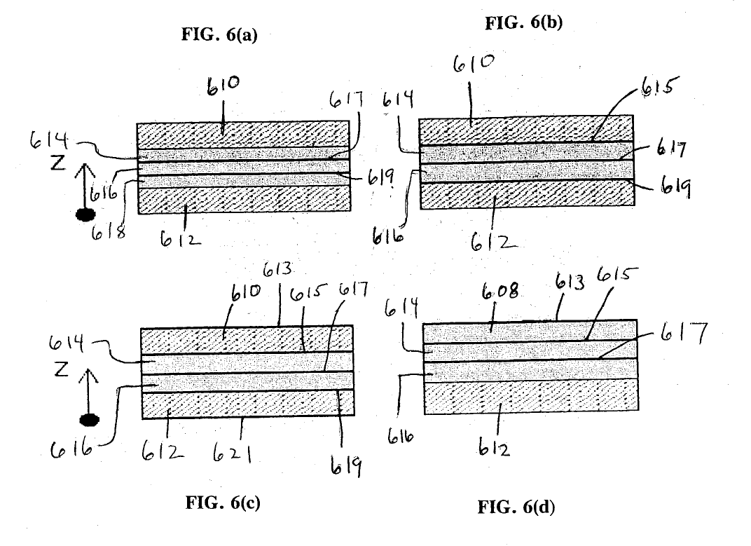

Electromagnetic properties of the skin layers and the foam layers used in the optimized absorbers are provided in Table II. These skin layers and foam layers were used for the optimized Connolly absorber in FIG. 5 and for other optimized absorbers discussed below and shown in FIGS. 6-10. The permittivity c of the woven E-glass/vinyl ester used in the optimized absorbers is (3.07, 0.056) and the permeability μ of the woven E-glass/vinyl ester is (1.0, 0.0). The permittivity of the core foam used in the spacer is (1.03, 0.0001) and the permeability is (1.0, 0.0).

Only normal incidence was considered and the first population P₀ was assembled of N=600 randomly created chromosomes. One chromosome X₁^{sc} was generated using the Connolly parameters, however, which are listed in Table I. The broadband frequency weight function wᵢ(2a) was used together with the following parameters in the objective function (9).

Number of design variables v=12, X={hₗ, . . . , h₆,G₁, . . . , G₆}

ƒ ε (2,18) GHz, number of frequencies n_{ƒ}=100

∠a=0.0, number of angles nₐ=1

Rₘᵢₙ=−50.0 dB

Angle weight function wⱼ(1)=1

Frequency weight function wᵢ(2a),ƒ₁=6.0 GHz, ƒ₂=18.0 GHz, wₗᵢₘ=5.0

The inventors repeated the optimization procedure several times with similar outputs. Slightly better results were obtained with a re-optimization that included one of the fittest chromosomes. The best result obtained, for the optimized configuration of the Jaumann absorber, is shown by the solid line 530 in FIG. 5, which indicates that the maximum reflection coefficient in the 7.5-18 GHz range has been reduced from −31.7 dB of the Connolly design to −38.9 dB; the reflected signal is 5.2 times smaller than the Connolly design. Optimized values of the design variables are listed in columns 1030 and 1040 of Table I. The Jaumann-type absorbers have also been optimized with other genetic algorithms as discussed, for example, in an article by B. Chambers et al. titled “Optimised design of Jaumann radar absorbing materials using a genetic algorithm,” published by the IEEE Proceeding-Radar Sonar and Navigation, vol. 143, no. 1, pp. 23-30 in 1996; and in an article by B. Chambers et al. titled “Design of wideband Jaumann radar absorbers with optimum oblique incidence performance,” published in Electronic Lett., vol. 30, no. 18, pp. 1530-1532, in 1994. In those articles, the authors optimize for desired reflection coefficient of Rₘₐₓ=−20 dB for three- and four-layer absorbers.

### EXAMPLES

The following examples are included to more clearly demonstrate the overall nature and effect of the invention. These examples are exemplary, not restrictive, of the invention. The described optimization procedure was applied to several numerical examples related to applications in laminated sandwich plates exposed to marine radars, for example, which usually operate in the frequency range of 8-12 GHz. Only the normal incident waves are considered in the computations. In a typical configuration, a foam layer is sandwiched between two outer, or skin, layers made of a woven E-glass/vinyl ester laminate having the parameters shown in Table II. Interleaved resistance carbon sheets are added to create an absorber.

In alternative embodiments, spacer layers may be lattice structures or space truss structures, either of which may be made of metal such as, for example, aluminum or titanium. In other alternative embodiments, the lattice structure or space truss structures may be made of polymer material, ceramic materials, balsa wood, paper based materials, or other organic materials.

FIG. 6 shows the configurations of three embedded (A-C) and one surface (D) absorber, optimized under different assumptions and constraints. FIG. 6(a) is a Type A configuration. It has two skin layers 610, 612 made of woven E-glass/vinyl ester, three layers 614, 616, 618 made of foam core material, and two resistive sheets 617, 619. The backing before layer 612 may be either free or metallic backing.

FIG. 6(b) is a Type B configuration. It has two skin layers 610, 612 made of woven E-glass/vinyl ester, two layers 614, 616 made of foam core material, and three resistive sheets 615, 617, 619. The backing layer before layer 612 may be either free or metallic backing.

FIG. 6(c) is a Type C configuration. It has two skin layers 610, 612 made of woven E-glass/vinyl ester, two layers 614, 616 made of foam core material, and five resistive sheets 613, 615, 617, 619, 621. The backing layer before layer 612 may be either free or metallic backing.

FIG. 6(d) is a Type D configuration. It has one layer 612 of woven E-glass/vinyl ester, three layers 608, 614, 616 of foam core material, and three resistive sheets 613, 615, 617. The backing layer before layer 612 may be either free or metallic backing.

Although the laminate and core thicknesses were kept within a reasonable range, no attempt was made to include mechanical performance criteria such as strength or stiffness in the optimization procedures. Electromagnetic material parameters are listed in Table II. Due to lack of needed material property data, all electromagnetic properties for a woven E-glass/vinyl ester were taken from an article by S. Mumby et al. entitled “Dielectric properties of some PTFE-reinforced thermosetting resin composites,” published in Proceedings of the 19^{th} Electrical Electronics Insulation Conference, Chicago, Ill., pp. 263-267 in 1989, as equal to those for an epoxy resin and e-PTFE+E-glass fibers. Similar material data are presented in an article by R. Moore et al. titled “Permittivity of Fiber Polymer Composites Environmental Effects: Comparison of Measurement and Theory,” published in Antennas and Propagation Society International Symposium, vol. 3, pp. 1204-1207 in 1990, for Kevlar or Astroquartz fibers and epoxy resin. The material parameters are assumed to remain constant through the frequency spectrum of the incident wave.

The sets of weight function parameters and Rₘᵢₙ values needed in Equation (9) were selected on the basis of parametric studies and applied to each of the Type A, B, and C absorbers; their values appear in Table III, together with those selected for the Type D absorbers. The initial populations P₀ were created randomly for all sandwich plates. Type A (FIG. 6(a)) and Type B (FIG. 6(b)) absorbers employ, respectively, two and three resistive sheets completely embedded inside the sandwich plate. Only one of the three resistive sheets 617 is inside the core in Type B, while the other two (615, 619) reside at the foam-laminate interfaces, hence this layup sequence should be as easy to fabricate as that of Type A. Type C adds two resistive sheets (613, 621) at both outer surfaces of the laminate to the Type B configuration, for a total of five resistive sheets 613, 615, 617, 619, 621.

As indicated by Equation (10), constraints were prescribed on the maximum and/or minimum thickness of the individual foam and laminate layers, and on the resistivities of the carbon sheets. Moreover, the thickness of the laminate layers was prescribed as equal to 12.7 mm (0.5 in.), except in the type A₃, B₃, and C₃ (discussed below), where the laminate thickness was optimized together with the foam layer thickness and sheet resistivities. The total thickness hₜₒₜ of the sandwich plates was left unconstrained. This produced many different total thicknesses with optimized absorption properties. Structural strength and stiffness requirements that may impose other thickness constraints could be included in the present procedure.

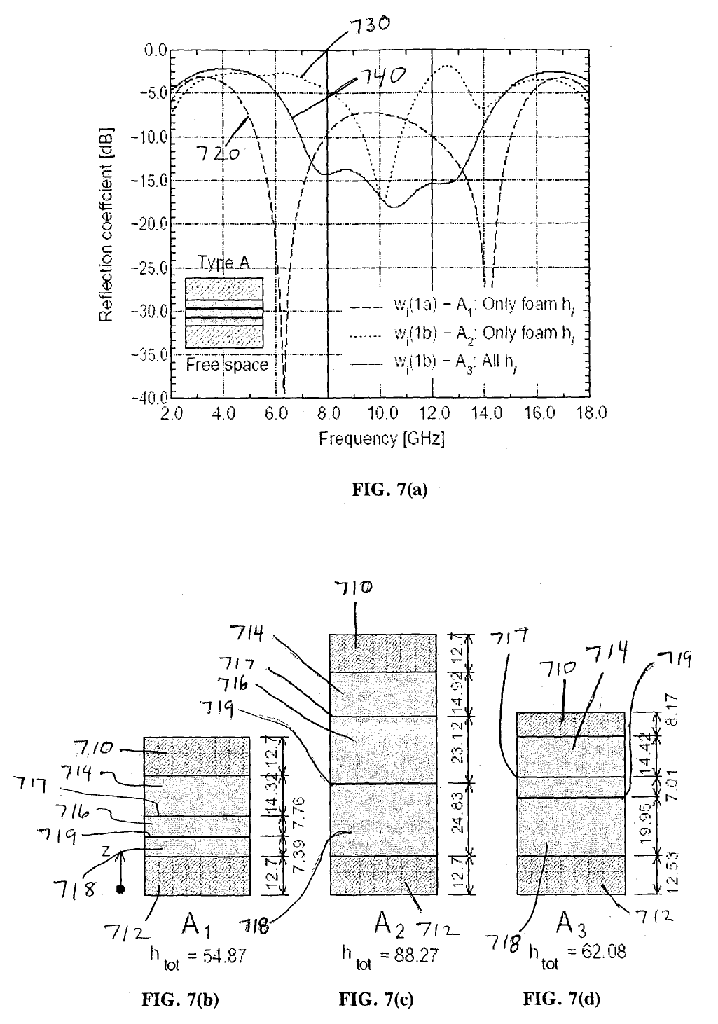

Table III lists the parameters used in the optimized Type A-D absorbers. In Table III, column 3000 refers to the type of absorbers that were optimized. Line 3001 refers to Absorber Types A₁, B ₁, and C₁ each of which have free backing before layers 712, 812, 912, respectively, as shown in FIGS. 7(b), 8(b), and 9(b). Line 3002 refers to Absorber Types A₂, B₂, and C₂ each of which have free backing before layers 712, 812, 912, respectively, as shown in FIGS. 7(c), 8(c), and 9(c). Line 3003 refers to Absorber Types A₃, B₃, and C₃ each of which have free backing before layers 712, 812, 912, respectively, as shown in FIGS. 7(d), 8(d), and 9(d). Responses of A, B, and C Type absorbers are shown in FIGS. 7(a), 8(a), and 9(a), respectively.

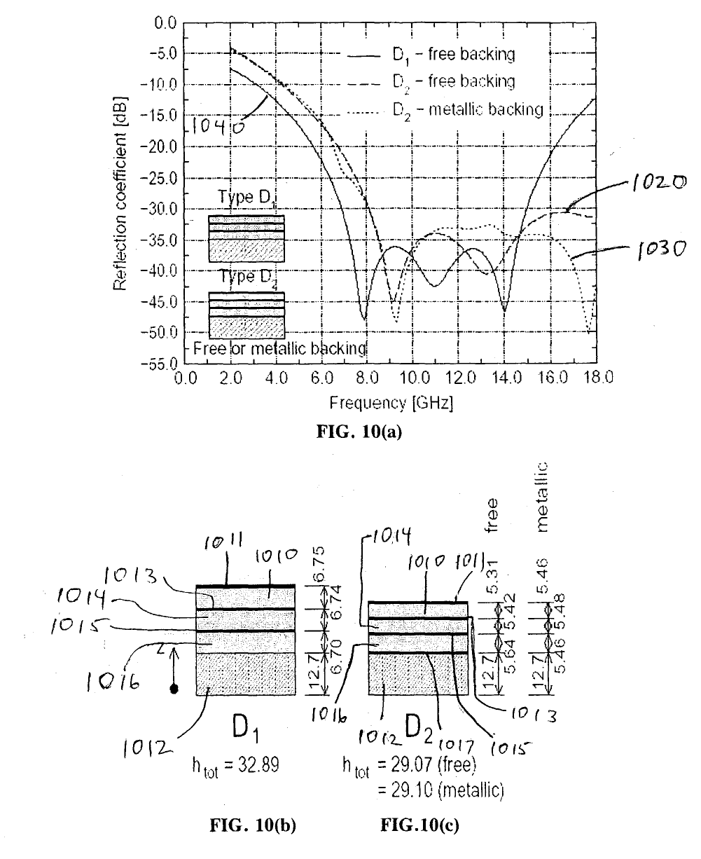

Line 3004 of Table III refers to Absorber Type D₁ having free backing before layer 1012, as shown in FIG. 10(b). Line 3005 refers to Absorber Type D₂ having free backing before layer 1012, as shown in FIG. 10(c). Line 3006 refers to Absorber Type D₂ having metallic backing before layer 1012, as also shown in FIG. 10(c). Responses of the Type D absorbers are shown in FIG. 10(a).

Column 3010 of Table III identifies the weight functions that were applied to respective absorber types. For example, the intersection of line 3001 and column 3010 shows that weight function wᵢ1(a) was applied to absorbers A₁, B₁, C₁. The intersection of line 3002 and column 3010 shows that weight function wᵢ(1b) was applied to absorbers A₂, B₂, C₂. Column 3020 identifies wₗᵢₘ, the values of the weight functions that were applied to respective absorber types. For example, line 3001 shows a weight value of 5.0 applied to absorbers A₁, B₁, C₁ and line 3002 shows a weight value of 3.0 applied to absorbers A₂, B₂, C₂. Column 3030 identifies the weight function multiplier values, if any, assigned to respective absorber types. For example, lines 3001, 3004, 3005, and 3006 show that no multiplier values were assigned to the absorber types listed on those lines. On the other hand, a multiplier value of 2.0 was assigned to the absorber types listed on line 3002 and a multiplier value of 1.5 was assigned to the absorber types listed on line 3003. Columns 3040 and 3050 identify the frequency ranges for which the absorber types were optimized. For example, line 3001 identifies a frequency range of 8.0 to 12.0 GHz for absorbers A₁, B₁, C₁ and line 3003 identifies a frequency range of 7.0 to 13.0 GHz for absorbers A₃, B₃, C₃. Column 3060 shows the desired, or target, reflection coefficient of the sandwich plate that is required. For example, line 3001 shows a desired reflection coefficient of −25.0 dB for absorbers A₁, B₁, C₁ and line 3004 shows a desired reflection coefficient of −45.0 dB for absorbers D₁.

Column 3070 of Table III identifies the lines in FIGS. 7(a), 8(a), and 9(a) which plot the responses of the optimized absorbers having the characteristics and parameters identified in the other columns of Table III. The dashed line listed in line 3001 refers to curves 720, 820, and 920 in FIGS. 7(a), 8(a), and 9(a), respectively. The dotted line listed in line 3002 refers to curves 730, 830, and 930 in FIGS. 7(a), 8(a), and 9(a), respectively. The solid line listed in line 3003 refers to curves 740, 840, and 940 in FIGS. 7(a), 8(a), and 9(a), respectively. The solid line listed in line 3004 refers to curve 1040 in FIG. 10. The dashed line listed in line 3005 refers to curve 1020 in FIG. 10(a). The dotted line listed in line 3006 refers to curve 1030 in FIG. 10(a).

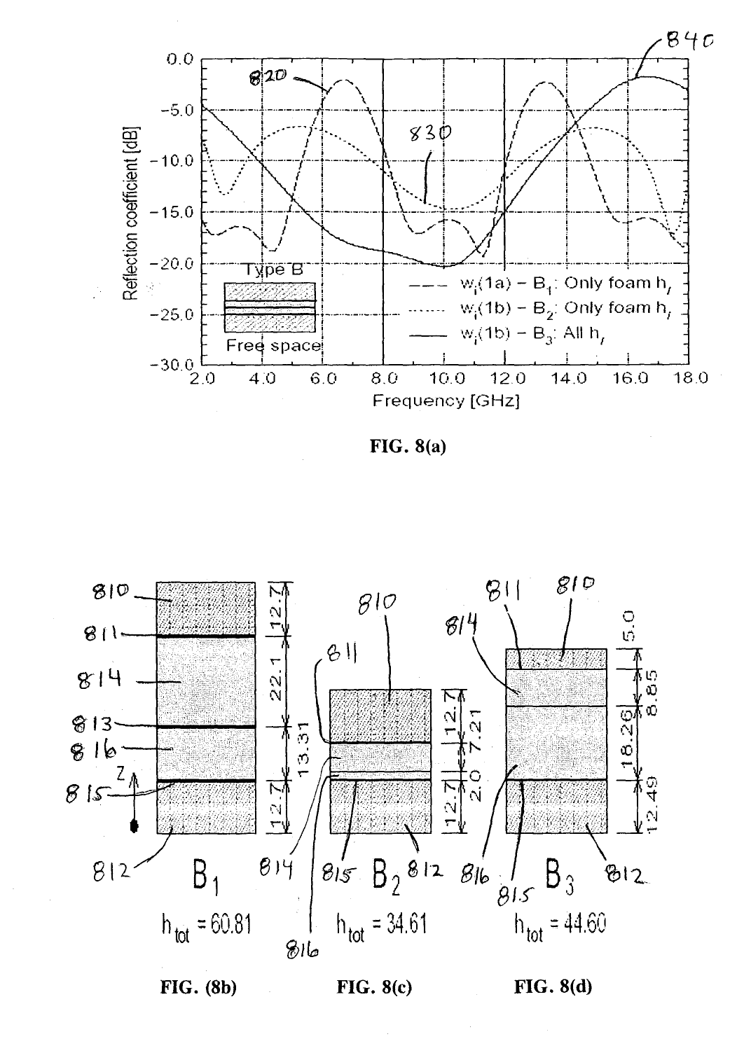

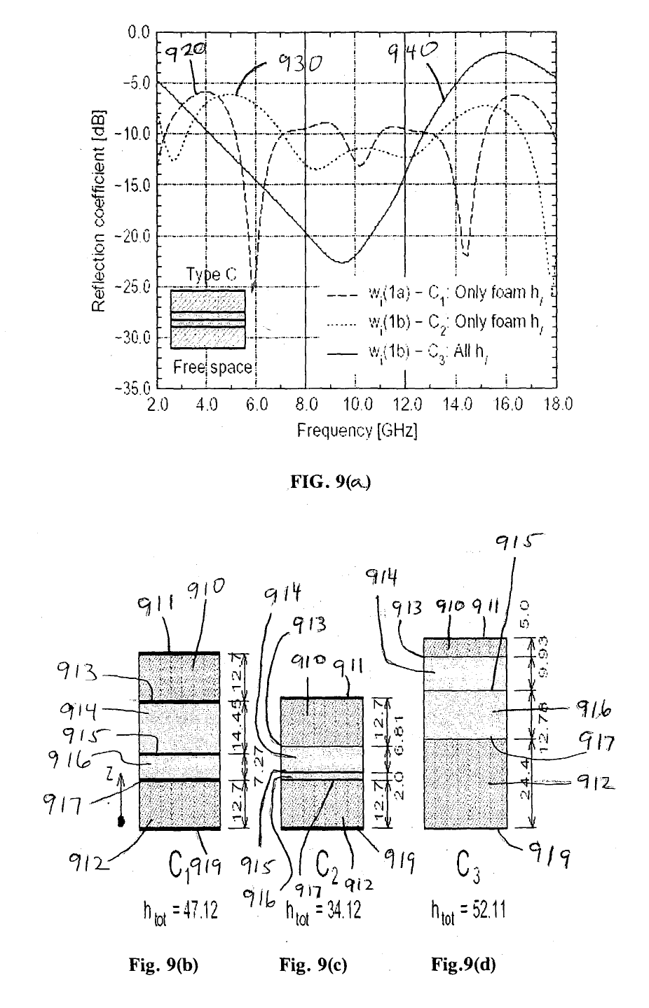

Results obtained for the embedded configurations A-C with free backing are shown in FIGS. 7(a), 8(a), and 9(a) and Tables IV, V, and VI. FIG. 7(a), depicting configuration A of FIG. 6(a) in the insert, shows optimized reflection coefficients as a function of the frequency spectrum. FIGS. 7(b), 7(c), and 7(d) show the dimensions of the five layers, in millimeters, for three different embodiments of the Type A optimized absorber of the invention. FIG. 8(a), depicting configuration B of FIG. 6(b) in the insert, shows optimized reflection coefficients as a function of the frequency spectrum. FIGS. 8(b), 8(c), and 8(d) show the dimensions of the four layers, in millimeters, for three different embodiments of the Type B optimized absorber of the invention. FIG. 9(a), depicting configuration C of FIG. 6(c) in the insert, shows optimized reflection coefficients as a function of the frequency spectrum. FIGS. 9(b), 9(c), 9(d) show the dimensions of the four layers, in millimeters, for three different embodiments of the Type C optimized absorber of the invention. FIG. 10(a), depicting configuration D of FIG. 6(d), shows optimized reflection coefficients as a function of the frequency spectrum. FIGS. 10(b) and 10(c) show the dimensions of the four layers, in millimeters, for the three different embodiments of the Type D optimized absorber of the invention. FIG. 10(c) shows the results of a configuration having a free backing before layer 1012 and the results of a configuration having a metallic backing.

Thus, FIGS. 7(a), 8(a), 9(a), and 10(a) contain curves showing the results of optimization and Tables IV, V, VI, and VII list the optimized characteristics of the absorbers which gave rise to the results shown in these Figures.

Specifically, Table IV shows the characteristics of the optimized Type A absorber listed in column 4000. Line 4001 lists the characteristics for optimized Type A₁, line 4002 lists the characteristics for optimized Type A₂, and line 4003 lists the characteristics for optimized Type A₃. Similarly, Table V shows the characteristics of optimized Type B absorbers listed in column 5000, listing the characteristics of optimized Type B₁, B₂, and B₃ absorbers in lines 5001, 5002, and 5003, respectively. Table VI shows the characteristics of optimized Type C absorbers listed in column 6000, listing the characteristics of optimized Type C₁, C₂, and C₃ absorbers in lines 6001, 6002, and 6003, respectively. Table VII shows the characteristics to optimized Type D absorbers listed in column 7000, listing the characteristics of an optimized Type D₁ absorber with free backing in line 7001, the characteristics of an optimized Type D₂ absorber with free backing in line 7002, and the characteristics of an optimized Type D₂ absorber with metallic backing in line 7003.

The columns in each Table list the specific characteristics. For example, column 4010 lists the thickness of the skin layer closest to the structure in which the absorber is embedded. In FIG. 7(b), the skin layer in column 4010, line 4001 is layer 712. Column 4020 lists the thickness of the foam layer which is immediately adjacent to the skin layer. In FIG. 7(b), layer 718 is the layer identified at the intersection of line 4001 and column 4020 and has a thickness of 7.39 mm. Column 4030 lists the thickness of the next foam layer. In FIG. 7(b), layer 716 is the layer identified at the intersection of line 4001 and column 4030 and has a thickness of 7.76 mm. Still referring to FIG. 7(b), layer 714 is the layer identified at the intersection of line 4001 and column 4040 and has a thickness of 14.32 mm. Skin layer 710 is the layer identified at the intersection of line 4001 and column 4050 and has a thickness of 12.7 mm. The last two columns in Table IV, columns 4060 and 4070, list the resistivity of resistive sheets 717 and 719 in FIG. 7(b). Column 4060 lists the resistivity of resistive sheet 719 as 423.79 Ω and column 4070 lists the resistivity of resistive sheet 717 as 755.57 Ω.

In FIGS. 7(a), 8(a), and 9(a), the dashed lines 720, 820, 920, respectively, represent reflection coefficients computed with the wᵢ(1a) weight function, fixed laminate layer thicknesses of 12.7 mm (0.5 in.), and optimized foam thicknesses and sheet resistivities; the resulting configurations are denoted as A₁, B₁, and C₁ in FIGS. 7(a) and 7(b), 8(a) and 8(b), and 9(a) and 9(b), respectively. As noted above, the specific characteristics of each of these optimized absorbers Types A₁, B₁, and C₁ are shown in Tables IV, V, and VI. For example, the characteristics of Type A₁ have been described above.

Similarly, the characteristics of Type B₁ absorbers are shown by the listing of numbers along line 5001 in Table V. It will be seen that there are two skin layers (columns 5010 and 5040 representing layers 812 and 810, respectively), two foam layers (columns 5020 and 5030 representing layers 816 and 814, respectively), and three resistivity sheets (columns 5050, 5060, and 5070 representing sheets 815, 813, and 811, respectively) depicted in Table V. In Table VI, there are two skin layers (columns 6010 and 6040 representing sheets 912 and 910, respectively), two foam layers (columns 6020 and 6030 representing layers 916 and 914, respectively), and five resistivity sheets (columns 6050, 6060, 6070, 6080, and 6090 representing layers 919, 917, 915, 913, and 911, respectively). Therefore, for example, line 6001 shows the characteristics of a Type C₁ absorber. In Table VII, there are one skin layer (column 7010 representing layer 1012), three foam layers (columns 7020, 7030, and 7040 representing layers 1016, 1014, and 1010, respectively), and four resistivity sheets (columns 7050, 7060, 7070, and 7080 representing sheets 1017, 1015, 1013, and 1011, respectively).

The dotted lines 730, 830, and 930 in FIGS. 7(a), 8(a), and 9(a), respectively, show reflection coefficients computed for the same free and fixed variables with the localized wᵢ(1b) frequency weight function, resulting in configurations denoted as A₂, B₂, and C₂ in FIGS. 7(a) and 7(c), 8(a) and 8(c), and 9(a) and 9(c), respectively. Finally, the solid lines 740, 840, and 940, respectively, refer to results obtained from solutions optimizing both foam layer and laminate thicknesses as well as sheet resistivities with the less localized wᵢ(1b) frequency weight function. These are denoted as A₃, B₃, and C₃ in FIGS. 7(a) and 7(d), 8(a) and 8(d), and 9(a) and 9(d), respectively. The characteristics of each of these absorbers are shown in Tables IV, V, and VI in lines 4003, 5003, and 6003, respectively.

As expected, selecting the weight function wᵢ(1a) provides more uniform reduction of the reflection coefficient within the frequency range ƒ₁ and ƒ₂, as shown in FIG. 2(a). On the other hand, the wᵢ(1b) weight function yields low reflection coefficient values close to the middle of the ƒ₁-ƒ₂ bandwidth. Constraining the thickness values of the laminate layers, as may often be dictated by structural requirements, tends to impair absorption capacity. Removing this constraint results in lower reflective coefficients, but also in thinner outer laminated layers; these may be accommodated in certain structural parts. Comparison of the results shows that the Type A₁ and A₂ absorbers have the highest reflection coefficient values in the selected frequency range. Although performance is improved somewhat by adding the third resistive sheet and using the Type B₁ or B₂ configurations, the surface resistive sheets in Type C₁ or C₂ absorbers yield negligible performance improvement. The most significant reduction in the reflection coefficients is obtained by including the laminate thicknesses among the optimized variables. This provides Rₘₐₓ<−15 dB in both Type B₃ and C₃ and Rₘₐₓ<−13.7 dB in Type A₃.

After obtaining the superior performance of the Jaumann absorber, the inventors analyzed several surface absorbers of Type D, with either free or metallic backing. FIG. 10(a) and Table VII present the results. FIG. 10(a) shows optimized reflection coefficients as a function of the frequency spectrum for Type D, which is depicted in FIG. 6(d). FIG. 10(b) shows three resistive sheets 1011, 1013, and 1015 and free backing in Type D₁. FIG. 10(c) shows four resistive sheets 1011, 1013, 1015, and 1017 and either free or metallic backing in Type D₂. In FIG. 10(a), the dashed line 1020 represents reflection coefficients for the configuration D₂ with the free backing, the dotted line 1030 represents reflection coefficients for the configuration D₂ with the metallic backing, and the solid line 1040 refers to results obtained for the D₁ with free backing.

The presented surface absorber configurations provide much lower reflection coefficients than the above Types A-C, with Rₘₐₓ=−30.6 dB for Type D₂ within 8-18 GHz bandwidth, and Rₘₐₓ=−36.2 dB for Type D₁ in the 7.5-14.5 GHz interval. Good absorption was obtained for both free and metallic backing of Type D₂, with very similar optimized design variables. These results suggest good efficiency of electromagnetic absorption for this structure regardless of backing. Although employing only three foam layers and three or four resistive sheets, the Type D absorbers offer performance comparable to that of the optimized Jaumann absorber with six foam layers and resistive sheets.

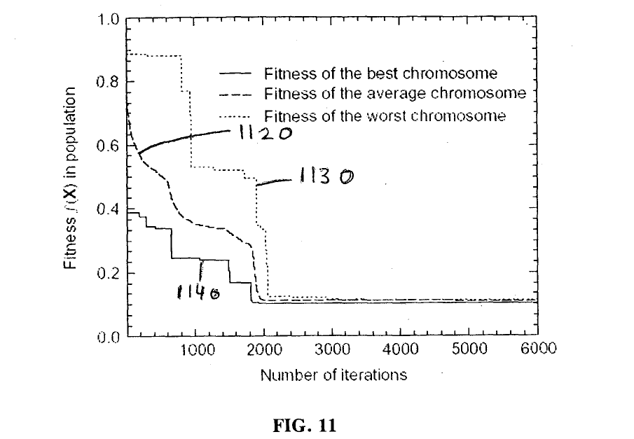

FIG. 11 illustrates the rate of convergence of the optimization procedure that was applied to the Type D₂ absorber. Dashed curve 1120 shows fitness of the average chromosome; dotted curve 1130 shows fitness of the worst chromosome; and solid curve 1140 shows fitness of the best chromosome. Fitness of the best chromosome in a randomly created population is ƒ(X)=0.408 and it drops to ƒ(X)=0.103 at completion of the optimization process. This represents a 25.2% improvement over the random design of the best individual, and a 14.5% improvement over the average fitness of the chromosomes in the population, where ƒ(X)=0.760→ƒ(X)=0.110.

Thus, a modified genetic algorithm, enhanced by the Augmented Simulated Annealing replacement procedure in conjunction with the disclosed weight functions, yields a design of optimized radar absorbing sandwich structures for marine applications. Efficiency of the procedure has been tested by optimizing the Connolly absorber consisting of six dielectric foam layers of constant thickness and variable resistivities of six resistive carbon sheets. When both the sheet resistivities and foam layer thicknesses were included among the optimized variables, the disclosed procedure yielded Rₘₐₓ=−38.9 dB and the reflected signal was 5.2 times smaller than the Connolly design in the 7.5-18 GHz frequency range.

Similar surface absorbers, Type D, consisting of only three foam layers and three or four resistive sheets are also very effective. Type D absorbers yielded reflection coefficients Rₘₐₓ=−30.6 dB in the 8-18 GHz frequency range for Type D₂ and Rₘₐₓ=−36.2 dB in the 7.4-14.5 GHz bandwidth for Type D₁.

For applications that require placing of the absorbing layers within a sandwich plate with glass/epoxy laminated faces, the disclosed method produced three design alternatives involving different numbers of absorbing layers with optimized resistivity values and spacer thicknesses. The high permittivity and thickness of the laminate surface layer impairs the absorbing capacity, however, of the embedded designs. Although the design optimization was constrained within the narrower 8-12 GHz bandwidth preferred by some marine radars, the inventors found the lowest value of the reflection coefficient of only Rₘₐₓ=−15.0 dB. In alternative embodiments, higher values would be obtained in a broader frequency range. In contrast, Rₘₐₓ=−30.6 and −36.2 dB was reached in the same narrower bandwidth with the Type D designs.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention.

TABLE I

| Solution | before optimization: Rₘₐₓ = −32 dB | | after optimization: R_{max = -39 dB} | |
|---|---|---|---|---|
| layer | thickness hᵢ | resistance R^{s}ₗ = 1/Gₗ | thickness hₗ | resistance R^{s}ₗ = 1/Gₗ |
| 1 | 3.56 | 236 | 3.56 | 236 |
| 2 | 3.56 | 471 | 3.52 | 481 |
| 3 | 3.56 | 943 | 3.56 | 943 |
| 4 | 3.56 | 1508 | 3.26 | 1543 |
| 5 | 3.56 | 2513 | 3.79 | 2567 |
| 6 | 3.56 | 9425 | 4.18 | 9465 |

TABLE II

| | Permittitivy, eᵣ | | Permeability,μᵣ | |
|---|---|---|---|---|
| Material | ε″ᵣ | ε″ᵣ | μ′ᵣ | μ″ᵣ |
| Woven E-glass/vinyl ester | 3.07 | 0.056 | 1.0 | 0.0 |
| Core foam, spacer | 1.03 | 0.0001 | 1.0 | 0.0 |

TABLE H

| | | | | | | | | Lines in |
|---|---|---|---|---|---|---|---|---|
| | Absorber | | | | f₁ | f₂ | Rₘᵢₙ | FIGS. |
| | Type | wᵢ | wₗᵢₘ | p | GHz | GHz | dB | 7-9 |
| 3001- | A₁-C₁ - | wᵢ (1b) | 5.0 | — | 8.0 | 12.0 | −25.0 | dashed |
| | free | | | | | | | |
| | backing | | | | | | | |
| 3002- | A₂-C₂ - | wᵢ (1b) | 3.0 | 2.0 | 8.0 | 12.0 | −25.0 | dotted |
| | free | | | | | | | |
| | backing | | | | | | | |
| 3003- | A₃-C₃ - | wᵢ (1b) | 3.0 | 1.5 | 7.0 | 13.0 | −25.0 | solid |
| | free | | | | | | | |
| | backing | | | | | | | |
| 3004- | D₁ - free | wᵢ (1a) | 5.0 | — | 7.0 | 15.0 | −45.0 | solid |
| | backing | | | | | | | |
| 3005- | D₂ - free | wᵢ (1a) | 5.0 | — | 6.0 | 18.0 | −45.0 | dashed |
| | backing | | | | | | | |
| 3006- | D₂ - | wᵢ (2a) | 5.0 | — | 6.0 | 18.0 | −45.0 | dotted |
| | metallic | | | | | | | |
| | backing | | | | | | | |
| | \| | \| | \| | \| | \| | \| | \| | \| |
| | 3000 | 3010 | 3020 | 3030 | 3040 | 3050 | 3060 | 3070 |

TABLE IV

| | | Laminate | Foam | Foam | Foam | Laminate | | |
|---|---|---|---|---|---|---|---|---|
| | Solution | h₁ | h₂ | h₃ | h₄ | h₅ | R^{s}₁ | R^{s}₂ |
| 4001- | wᵢ (1a)-A₁: foam hₗ | 12.7 | 7.39 | 7.76 | 14.32 | 12.7 | 423.79 | 755.57 |
| 4002- | wᵢ (1b)-A₂: foam hₗ | 12.7 | 24.83 | 23.12 | 14.92 | 12.7 | 51.8 | 168.17 |
| 4003- | wᵢ (1b)-A₃: each hₗ | 12.53 | 19.95 | 7.01 | 14.42 | 8.17 | 50.19 | 332.30 |
| | \| | \| | \| | \| | \| | \| | \| | \| |
| | 4000 | 4010 | 4020 | 4030 | 4040 | 4050 | 4060 | 4070 |

TABLE V

| | | Laminate | Foam | Foam | Laminate | | | |
|---|---|---|---|---|---|---|---|---|
| | Solution | h₁ | h₂ | h₃ | h₄ | R^{s}₁ | R^{s}₂ | R^{s}₃ |
| 5001- | wᵢ (1a)-B₁: foam hₗ | 12.7 | 13.31 | 22.1 | 12.7 | 50 | 50 | 175.01 |
| 5002- | wᵢ (1b)-B₂: foam hₗ | 12.7 | 2.0 | 7.21 | 12.7 | 77.16 | 50 | 185.0 |
| 5003- | wᵢ (1b)-B₃: each hₗ | 12.49 | 1.26 | 8.85 | 5.0 | 10000 | 50 | 158.07 |
| | \| | \| | \| | \| | \| | \| | \| | \| |
| | 5000 | 5010 | 5020 | 5030 | 5040 | 5050 | 5060 | 5070 |

TABLE VI

| | | Lam. | Foam | Foam | Lam. | | | | | |
|---|---|---|---|---|---|---|---|---|---|---|
| | Solution | h₁ | h₂ | h₃ | h₄ | R^{s}₁ | R^{s}₂ | R^{s}₃ | R^{s}₄ | R^{s}₅ |
| 6001- | wᵢ (1a)-C₁: foam hₗ | 12.7 | 7.27 | 14.45 | 12.7 | 265.5 | 10000 | 477.5 | 784.89 | 10000 |
| 6002- | wᵢ (1b)-C₂: foam hₗ | 12.7 | 2.0 | 6.81 | 12.7 | 73.5 | 50 | 50 | 221.97 | 10000 |
| 6003- | wᵢ (1b)-C₃: each hₗ | 24.4 | 12.78 | 9.39 | 5.0 | 758.0 | 63.68 | 50 | 145.31 | 10000 |
| | \| | \| | \| | \| | \| | \| | \| | \| | \| | \| |
| | 6000 | 6010 | 6020 | 6030 | 6040 | 6050 | 6060 | 6070 | 6080 | 6090 |

TABLE VII

| | | Lam. | Foam | Foam | Foam | | | | |
|---|---|---|---|---|---|---|---|---|---|
| | Solution | h₁ | h₂ | h₃ | h₄ | R^{s}₁ | R^{s}₂ | R^{s}₃ | R^{s}₄ |
| 7001- | Type D₁-free | 12.70 | 6.697 | 6.744 | 6.748 | — | 438.175 | 791.146 | 2549.775 |
| 7002- | Type D₂-free | 12.70 | 5.637 | 5.417 | 5.314 | 50.0 | 277.335 | 755.521 | 2992.971 |
| 7003- | Type D₂-metallic | 12.70 | 5.463 | 5.480 | 5.463 | 50.0 | 277.335 | 755.521 | 3006.05 |
| | \| | \| | \| | \| | \| | \| | \| | \| | \| |
| | 7000 | 7010 | 7020 | 7030 | 7040 | 7050 | 7060 | 7070 | 7080 |

What is claimed:

1. A method of minimizing reflectivity of an electromagnetic absorbing structure including at least one skin layer having a thickness, at least one spacer layer having a thickness, and at least one resistivity sheet having a resistivity, the method comprising:
(a) specifying a frequency range over which to operate the electromagnetic absorbing structure;
(b) determining the thickness of the at least one skin layer;
(c) determining the thickness of the at least one spacer layer; and
(d) determining the resistivity of the at least one resistivity sheet.

2. The method of claim 1, further comprising the step of defining an objective function, including at least one weight function, wherein steps (b) to (d) include using a genetic algorithm to minimize the objective function to specify an optimized thickness of the at least one skin layer, an optimized thickness of the at least one spacer layer, and an optimized resistivity of the at least one resistivity sheet.

3. The method of claim 2, wherein the at least one skin layer includes two skin layers, respective ones of the skin layers having respective thicknesses, and wherein step (b) includes minimizing the objective function, including the at least one weight function, using the genetic algorithm and the weight function to specify the respective thicknesses of the skin layers.

4. The method of claim 3, wherein:
the at least one spacer layer includes a plurality of spacer layers, respective ones of the spacer layers having respective thicknesses, and step (c) includes minimizing the objective function, including the at least one weight function, using the genetic algorithm and weight function to specify the respective spacer layer thicknesses; and
the at least one resistivity sheet includes a plurality of carbon sheets, respective ones of the carbon sheets having respective resistivities, and step (d) includes minimizing the objective function using the genetic algorithm and weight function to specify the respective carbon sheet resistivities.

5. The method of claim 4, further comprising the step of specifying respective distances between respective ones of the carbon sheets.

6. The method of claim 4, wherein each of the plurality of spacer layers are made from foam and including the step of placing one of the plurality of carbon sheets between two of the plurality of foam layers.

7. The method of claim 1, wherein the electromagnetic absorbing structure is an embedded structure.

8. The method of claim 1, wherein the electromagnetic absorbing structure is a surface structure.

9. An electromagnetic absorbing structure operating over a frequency range, the electromagnetic absorbing structure comprising:
at least one skin layer having a first specified thickness;
at least one spacer layer having a second specified thickness; and
at least one resistivity sheet having a specified resistivity.

10. The electromagnetic absorbing structure of claim 9, wherein the first thickness, the second thickness, and the resistivity are specified in accordance with minimizing an objective function, including at least one weight function, with a genetic algorithm.

11. An electromagnetic absorbing structure operating over a frequency range, the electromagnetic absorbing structure comprising:
at least one skin layer having a specified skin layer thickness;
a plurality of spacer layers, respective ones of the spacer layers having respective specified spacer layer thicknesses; and
a plurality of resistive sheets, respective ones of the resistive sheets having respective specified resistive sheet resistivities.

12. The electromagnetic absorbing structure of claim 11, wherein the skin layer thickness, the respective spacer layer thicknesses, and the respective resistive sheet resistivities are specified in accordance minimizing an objective function, including at least one weight function, with a genetic algorithm.

13. The electromagnetic absorbing structure of claim 11, wherein the electromagnetic absorbing structure is an embedded structure.

14. The electromagnetic absorbing structure of claim 11, wherein the electromagnetic absorbing structure is a surface structure.

15. The electromagnetic absorbing structure of claim 11, wherein at least one resistive sheet is disposed between two of the spacer layers.
